(19) United States
(12) Patent Application Publication
(10) Pub. No.: US 2005/0215677 A1
(43) Pub. Date: Sep. 29, 2005

(54) Thermoplastic compositions and process for making thereof

(76) Inventors: Satish Kumar Gaggar, Parkersburg, WV (US); Richard Carl Crosby, Castleton, NY (US); Charles M. Hutzler, Parkersburg, WV (US)

Correspondence Address: Henry H. Gibson;GE Plastics, One Plastics Avenue, Pittsfield, MA, 01201, US

(21) Appl. No.: 10/460,630

(22) Filed: Jun. 12, 2003

Related U.S. Application Data
(60) Provisional application No. 60/388,668, filed on Jun. 13, 2002.

(51) Int. Cl. C08K 5/49

(52) U.S. Cl. 524/115; 523/201

(57) ABSTRACT

A non-opaque thermoplastic alloy comprising a continuous phase and a discontinuous phase, wherein the discontinuous phase is immiscible with the continuous phase. The non-opaque alloy may be translucent or transparent. The continuous phase is preferably polycarbonate, the discontinuous phase is preferably a transparent ABS.

### CROSS REFERENCE TO RELATED APPLICATIONS

This application claims priority to U.S. Provisional Application Ser. No. 60/388,668 filed on Jun. 13, 2002, which is incorporated herein by reference in its entirety.

### FIELD OF THE INVENTION

This invention relates to transparent or translucent thermoplastic molding compositions comprising polycarbonate, optionally containing special-effect colorants and processes for producing such compositions.

### BACKGROUND OF THE INVENTION

Polycarbonate (PC) is a high-performance plastic with good impact strength. In addition to ductility (impact strength), general-purpose PC has high transparency, good dimensional stability, low water absorption, good stain resistance and a wide range of colorability. A weak area for PC is its relatively limited range of chemical resistance, which necessitates careful appraisal of applications involving contact with certain organic solvents, some detergents, strong alkali, certain fats, oils and greases. Also, another weak area of PC is that it has a high melt viscosity which makes it difficult to mold. Medium to high flow PC grades suffer from the fact that the low temperature ductility is sacrificed for a better flow. Finally, PC formulations with special-effect colorants like metallic type pigments or mineral flakes are in general very brittle at room temperature.

This invention deals with these shortcomings and as such proposes a material that has an unique property profile in terms of transparency, improved chemical resistance, higher flow, low temperature ductility at −20 to −40° C. (high impact strength), even with special-effect colorants.

A widely used method to increase low temperature impact resistance, is the addition of impact modifiers to the PC compositions. Adding minor amounts of methylacrylate-butadiene-styrene (MBS) rubbers or Acrylonitrile-butadiene-styrene (ABS) rubbers results in lower D/B transition temperatures. The major drawback of these modifications is that, even with only 1% addition levels, the transparency decreases, taking away one of the key properties of PC. This opaqueness is caused by the relatively high refractive index (RI) of the aromatic PC (1.58) compared to the more aliphatic rubbery and/or siloxane components, which do have RI values in the range 1.48-1.56.

It is highly desired to obtain low temperature impact and high transparency at the same time. In some cases some translucency could already be very beneficial, since it is not needed or even desired to have complete transparency such as in lighting housings.

U.S. Pat. No. 6,040,382 describes how optical clarity of a blend of 2 transparent, immiscible polymers can be improved by addition of a third polymer which is selectively miscible with one of the two original immiscible polymers. The concept is based on matching refractive indexes. This patent is directed to compositions of monovinyl aromatic-conjugated diene copolymers (like styrene-butadiene block co-polymers), styrene-maleic anhydride copolymers (SMA) and poly (alpha-methylstyrene).

U.S. Pat. Nos. 5,891,962, 5,494,969 and 5,614,589; respectively, describe specific formulations of rubber modified styrene; cycloolefin polymer composites; and methacrylate-acrylonitrile-butadiene-styrene copolymers with urethane copolymer. In these compositions, polymers are being replaced by co-polymers (f.i. polystyrene by a co-polymer of styrene and alkyl(meth)acrylate) to match the RI of a rubbery component. It's also possible to modify the rubbery component to match the RI of the polymer matrix, as disclosed in U.S. Pat. Nos. 5,321,056 and 5,409,967. The focus of all these patents is to chemically modify the ingredients to match RI to achieve transparency.

U.S. Pat. No. 5,859,119 which focuses on opaque PC blends, discloses a reinforced, molding compositions with desirable ductility and melt flow properties. The composition contains a cyclo aliphatic polyester resin, an impact modifying amorphous resin which increases the ductility of the polyester resin but reduces the melt flow properties thereof, and a high molecular weight polyetherester polymer which increases the melt flow properties of the polyester polymer without reducing the ductility thereof, and a glass filler to reinforce and stiffen the composition and form a reinforced molding composition.

U.S. Pat. No. 4,188,314 describes shaped articles (such as sheet and helmets) of blends of 25-98 parts by weight (pbw) of an aromatic polycarbonate and 2-75 pbw of a poly cyclohexane dimethanol phthalate where the phthalate is from 5-95% isophthalate and 95-10% terephthalate.

There are other patents that deal with polycarbonate polycyclohexane dimethanol phthalate blends for example; U.S. Pat. Nos. 4,125,572, 4,391,954, 4,786,692, 4,897,453 and 5,478,896.

There is a need to prepare polycarbonate blends and articles made from them that are transparent or translucent, having low temperature impact resistance, improved chemical resistance compared to polycarbonate, and good melt processability.

### SUMMARY OF THE INVENTION

There is provided, a transparent molding composition having improved ductility and melt flow properties comprising a uniform blend of:
a) a miscible resin blend of a polycarbonate resin and an additive selected from the group consisting of: (i) a cycloaliphatic polyester resin, said cycloaliphatic polyester resin comprising the reaction product of an aliphatic C₂-C₁₂ diol or chemical equivalent and a C₆-C₁₂ aliphatic diacid or chemical equivalent, said cycloaliphatic polyester resin containing at least about 80% by weight of a cycloaliphatic dicarboxylic acid, or chemical equivalent, and/or of a cycloaliphatic diol or chemical equivalent; (ii) resorcinol bis (diphenylphosphate); and (iii) a polycarbonate copolymer or mixtures thereof;
b) a dispersed phase comprising an impact modifying resin;
   said blend of polycarbonate and additive having an index of refraction which substantially matches the index of refraction of said impact modifier.

The invention further relates to transparent or translucent polycarbonate blends, wherein the dispersed phase comprises a clear impact modified acrylic copolymer containing irregular domains of rubber.

The invention also relates to transparent polycarbonate blends wherein the refractive index of the polycarbonate is adjusted by the addition of a polyester derived from cycloaliphatic diol and cycloaliphatic diacid compounds.

### BRIEF DESCRIPTION OF THE DRAWINGS

Referring now to the following Figures, in which:

FIGS. 1 and 2 are Transmission Electron Micrographs showing the morphology of one of the embodiments of the invention, the use of a dispersed phase comprising a clear impact modified acrylic copolymer utilizing a block styrene butadiene rubber.

### DETAILED DESCRIPTION OF THE INVENTION

A typical thermoplastic composition according to the invention comprises a blend of thermoplastic resin or resins and miscible additive or additives (hereinafter called “the matrix” or the continuous phase), and transparent dispersed thermoplastic particles (hereinafter called “dispersed phase”).

Articles from such composition have a percent light transmission above 60%, a haze of less than 30%, and a clarity of greater than 70% but less than 100%, unless such articles are transparent. To obtain these optical characteristics, the matrix and the dispersed phase must be selected carefully. In one embodiment, they have refractive indices that differ by no more than 0.01.

I. Matrix Materials. Preferred thermoplastics for use in the matrix materials include polycarbonates, polyetherimides, transparent carboxylates, glycerol tricarboxylates, polyolefins, alkyl waxes and amides. In a most preferred embodiment, the matrix material is a polycarbonate.
A. Polycarbonate The polycarbonate for use in the matrix of present invention comprise the divalent residue of dihydric phenols, Ar′, bonded through a carbonate linkage and are preferably represented by the general formula III: 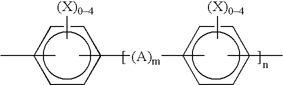
wherein A is a divalent hydrocarbon radical containing from 1 to about 15 carbon atoms or a substituted divalent hydrocarbon radical containing from 1 to about 15 carbon atoms; each X is independently selected from the group consisting of hydrogen, halogen, and a monovalent hydrocarbon radical such as an alkyl group of from 1 to about 8 carbon atoms, an aryl group of from 6 to about 18 carbon atoms, an arylalkyl group of from 7 to about 14 carbon atoms, an alkoxy group of from 1 to about 8 carbon atoms; and m is 0 or 1 and n is an integer of from 0 to about 5. Ar′ may be a single aromatic ring like hydroquinone or resorcinol, or a multiple aromatic ring like biphenol or bisphenol A.

The dihydric phenols employed are known, and the reactive groups are thought to be the phenolic hydroxyl groups. Typical of some of the dihydric phenols employed are bis-phenols such as bis(4-hydroxyphenyl)methane, 2,2-bis(4-hydroxyphenyl)propane (also known as bisphenol-A), 2,2-bis(4-hydroxy-3,5-dibromo-phenyl)propane; dihydric phenol ethers such as bis(4-hydroxyphenyl)ether, bis(3,5-dichloro-4-hydroxyphenyl)ether; p,p′-dihydroxydiphenyl and 3,3′-dichloro-4,4′-dihydroxydiphenyl; dihydroxyaryl sulfones such as bis(4-hydroxyphenyl)sulfone, bis(3,5-dimethyl-4-hydroxyphenyl)sulfone, dihydroxy benzenes such as resorcinol, hydroquinone, halo- and alkyl-substituted dihydroxybenzenes such as 1,4-dihydroxy-2,5-dichlorobenzene, 1,4-dihydroxy-3-methylbenzene; and dihydroxydiphenyl sulfides and sulfoxides such as bis(4-hydroxyphenyl)sulfide, bis(4-hydroxy-phenyl)sulfoxide and bis(3,5-dibromo-4-hydroxyphenyl)sulfoxide. A variety of additional dihydric phenols are available and are disclosed in U.S. Pat. Nos. 2,999,835, 3,028,365 and 3,153,008; all of which are incorporated herein by reference. It is, of course, possible to employ two or more different dihydric phenols or a combination of a dihydric phenol with a glycol.

The carbonate precursors are typically a carbonyl halide, a diarylcarbonate, or a bishaloformate. The carbonyl halides include, for example, carbonyl bromide, carbonyl chloride, and mixtures thereof. The bishaloformates include the bishaloformates of dihydric phenols such as bischloroformates of 2,2-bis(4-hydroxyphenyl)-propane, hydroquinone, and the like, or bishaloformates of glycol, and the like. While all of the above carbonate precursors are useful, carbonyl chloride, also known as phosgene, and diphenyl carbonate are preferred.

The aromatic polycarbonates can be manufactured by any processes such as by reacting a dihydric phenol with a carbonate precursor, such as phosgene, a haloformate or carbonate ester in melt or solution. U.S. Pat. No. 4,123,436 describes reaction with phosgene and U.S. Pat. No. 3,153,008 describes a transesterification process.

Preferred polycarbonate will be made of dihydric phenols that result in resins having low birefringence for example dihydric phenols having pendant aryl or cup shaped aryl groups like: Phenyl-di(4-hydroxyphenyl) ethane (acetophenone bisphenol); Diphenyl-di(4-hydroxyphenyl) methane (benzophenone bisphenol); 2,2-bis(3-phenyl-4-hydroxyphenyl) propane; 2,2-bis-(3,5-diphenyl-4-hydroxyphenyl) propane; bis-(2-phenyl-3-methyl-4-hydroxyphenyl) propane; 2,2′-bis(hydroxyphenyl)fluorene; 1,1-bis(5-phenyl-4-hydroxyphenyl)cyclohexane; 3,3′-diphenyl-4,4′-dihydroxy diphenyl ether; 2,2-bis(4-hydroxyphenyl)-4,4-diphenyl butane; 1,1-bis(4-hydroxyphenyl)-2-phenyl ethane; 2,2-bis(3-methyl-4-hydroxyphenyl)-1-phenyl propane; 6,6′-dihdyroxy-3,3,3′,3′-tetramethyl-1,1′-spiro(bis)indane (hereinafter “SBI”), or dihydric phenols derived from spiro biindane.

Other dihydric phenols which are typically used in the preparation of the polycarbonates are disclosed in U.S. Pat. Nos. 2,999,835, 3,038,365, 3,334,154 and 4,131,575. Branched polycarbonates are also useful, such as those described in U.S. Pat. Nos. 3,635,895 and 4,001,184. Polycarbonate blends include blends of linear polycarbonate and branched polycarbonate.

It is also possible to employ two or more different dihydric phenols or a copolymer of a dihydric phenol with an aliphatic dicarboxylic acids like; dimer acids, dodecane dicarboxylic acid, adipic acid, azelaic acid in the event a carbonate copolymer or interpolymer rather than a homopolymer is desired for use in the preparation of the polycarbonate mixtures of the invention. Most preferred are aliphatic C5 to C12 diacid copolymers.

The preferred polycarbonates are preferably high molecular weight aromatic carbonate polymers have an intrinsic viscosity (as measured in methylene chloride at 25° C.) ranging from about 0.30 to about 1.00 dl/gm. Polycarbonates may be branched or unbranched and generally will have a weight average molecular weight of from about 10,000 to about 200,000, preferably from about 20,000 to about 100,000 as measured by gel permeation chromatography. It is contemplated that the polycarbonate may have various known end groups.

A. Miscible Additives: Applicants have surprisingly found it possible to control the refractive index of the matrix or continuous phase by the use of a miscible additive as a second component. The miscible additives are selected from the group of 1) cycloaliphatic polyesters; 2) resorcinol bis(diphenylphosphate) (RDP); and 3) a polycarbonate block copolymer. A most preferred miscible additive is a cycloaliphatic polyester.
1. Cycloaliphatic polyester as an additive: This comprises a polyester having repeating units of the formula I: 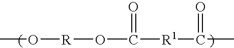
where at least one R or R1 is a cycloalkyl containing radical.

The polyester is a condensation product where R is the residue of an aryl, alkane or cycloalkane containing diol having 6 to 20 carbon atoms or chemical equivalent thereof, and R1 is the decarboxylated residue derived from an aryl, aliphatic or cycloalkane containing diacid of 6 to 20 carbon atoms or chemical equivalent thereof with the proviso that at least one R or R1 is cycloaliphatic. Preferred polyesters of the invention will have both R and R1 cycloaliphatic.

The present cycloaliphatic polyesters are condensation products of aliphatic diacids, or chemical equivalents and aliphatic diols, or chemical equivalents. The present cycloaliphatic polyesters may be formed from mixtures of aliphatic diacids and aliphatic diols but must contain at least 50 mole % of cyclic diacid and/or cyclic diol components, the remainder, if any, being linear aliphatic diacids and/or diols. The cyclic components are necessary to impart good rigidity to the polyester and to allow the formation of transparent blends due to favorable interaction with the polycarbonate resin.

The polyester resins are typically obtained through the condensation or ester interchange polymerization of the diol or diol equivalent component with the diacid or diacid chemical equivalent component.

R and R1 are preferably cycloalkyl radicals, wherein a preferred cycloaliphatic radical R1 is derived from the 1,4-cyclohexyl diacids and most preferably greater than 70 mole % thereof in the form of the trans isomer. The preferred cycloaliphatic radical R is derived from the 1,4-cyclohexyl primary diols such as 1,4-cyclohexyl dimethanol, most preferably more than 70 mole % thereof in the form of the trans isomer.

Other diols useful in the preparation of the polyester resins for use as the miscible additive are straight chain, branched, or cycloaliphatic alkane diols and may contain from 2 to 12 carbon atoms. Examples of such diols include but are not limited to ethylene glycol; propylene glycol, i.e., 1,2- and 1,3-propylene glycol; 2,2-dimethyl-1,3-propane diol; 2-ethyl, 2-methyl, 1,3-propane diol; 1,3- and 1,5-pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; 2,2,4,4-tetramethyl-1,3-cyclobutanediol (TMCBD), triethylene glycol; 1,10-decane diol; and mixtures of any of the foregoing. Preferably a cycloaliphatic diol or chemical equivalent thereof and particularly 1,4-cyclohexane dimethanol or its chemical equivalents are used as the diol component.

Chemical equivalents to the diols include esters, such as dialkylesters, diaryl esters and the like.

The diacids useful in the preparation of the aliphatic polyester resins preferably are cycloaliphatic diacids. This is meant to include carboxylic acids having two carboxyl groups each of which is attached to a saturated carbon. Preferred diacids are cyclo or bicyclo aliphatic acids, for example, decahydro naphthalene dicarboxylic acids, norbornene dicarboxylic acids, bicyclo octane dicarboxylic acids, 1,4-cyclohexanedicarboxylic acid or chemical equivalents, and most preferred is trans-1,4-cyclohexanedicarboxylic acid or chemical equivalent. Linear dicarboxylic acids like adipic acid, azelaic acid, dicarboxyl dodecanoic acid and succinic acid may also be useful.

Cyclohexane dicarboxylic acids and their chemical equivalents can be prepared, for example, by the hydrogenation of cycloaromatic diacids and corresponding derivatives such as isophthalic acid, terephthalic acid or naphthalenic acid in a suitable solvent such as water or acetic acid using a suitable catalysts such as rhodium supported on a carrier such as carbon or alumina. See, Friefelder et al., Journal of Organic Chemistry, 31, 3438 (1966); U.S. Pat. Nos. 2,675,390 and 4,754,064. They may also be prepared by the use of an inert liquid medium in which a phthalic acid is at least partially soluble under reaction conditions and with a catalyst of palladium or ruthenium on carbon or silica. See, U.S. Pat. Nos. 2,888,484 and 3,444,237.

Typically, in the hydrogenation, two isomers are obtained in which the carboxylic acid groups are in cis- or trans-positions. The cis- and trans-isomers can be separated by crystallization with or without a solvent, for example, n-heptane, or by distillation. The cis-isomer tends to blend better; however, the trans-isomer has higher melting and crystallization temperatures and may be preferred. Mixtures of the cis- and trans-isomers are useful herein as well. When the mixture of isomers or more than one diacid or diol is used, a copolyester or a mixture of two polyesters may be used as the present cycloaliphatic polyester resin.

Chemical equivalents of these diacids include esters, alkyl esters, e.g., dialkyl esters, diaryl esters, anhydrides, salts, acid chlorides, acid bromides, and the like. The preferred chemical equivalents comprise the dialkyl esters of the cycloaliphatic diacids, and the most favored chemical equivalent comprises the dimethyl ester of the acid, particularly dimethyl-1,4-cyclohexane-dicarboxylate.

A preferred cycloaliphatic polyester is poly(cyclohexane-1,4-dimethylene cyclohexane-1,4-dicarboxylate) also referred to as poly(1,4-cyclohexane-dimethanol-1,4-dicarboxylate) (PCCD). The favored PCCD has a cis/trans formula.

The polyester polymerization reaction is generally run in the melt in the presence of a suitable catalyst such as a tetrakis (2-ethyl hexyl) titanate, in a suitable amount, typically about 50 to 200 ppm of titanium based upon the final product.

The preferred aliphatic polyesters used in the present molding compositions have a glass transition temperature (Tg) which is above 50° C., more preferably above 80° C. and most preferably above about 100oC.

An advantage of adding aliphatic polyesters to PC is that their low glass transition temperature (Tg) improves the flow of PC (or impact modified PC) significantly, resulting in an overall very favorable flow/impact balance. Another advantage is that the polyester improves the overall chemical resistance towards various chemicals that are very aggressive towards straight PC. Examples of these chemicals are acetone, coppertone, gasoline, toluene etc.

As discussed above, the final polycarbonate grade has a unique property profile in terms of transparency combined with low temperature ductility, flow and chemical resistance. The exact ductility can be adjusted by the amount of impact modifier. All impact modifiers outlined above do have an unique PC/PCCD ratio to be used successfully, which means one has the choice to pick a PC/PCCD ratio that fits in the application requirements (heat, flow, chemical resistance are directly determined by the PC/PCCD ratio).

Also contemplated herein as miscible additives are the above polyesters with from about 1 to about 50 percent by weight, of units derived from polymeric aliphatic acids and/or polymeric aliphatic polyols to form copolyesters. The aliphatic polyols include glycols, such as poly(ethylene glycol) or poly(butylene glycol). Such polyesters can be made following the teachings of, for example, U.S. Pat. Nos. 2,465,319 and 3,047,539.

2. RDP as an additive: In one embodiment of the invention, the miscible additive is an oligomeric additive such as such as resorcinol bis(diphenylphosphate) (RDP).

3. Polycarbonate copolymer: In another embodiment of the invention, the miscible additive is a polycarbonate copolymer such as PC-SP dodecane-PC copolymer, a polycarbonate co-polymer incorporating dodecanedioic acid and commercially available from General Electric Company.

The refractive index of the blend of the two components in the matrix, e.g., polycarbonate and a miscible additive selected from RDP, a PC copolymer, or a cycloaliphatic polyester can be controlled by varying their relative amounts and as long as the two phases are miscible in the proportions being used, the continuous phase or the matrix will be transparent.

In one embodiment, a mixture of polycarbonate and poly(1,4-cyclohexanedimethanol-1,4-cyclohexanedicarboxylate) (PCCD) is used, wherein the polycarbonate has a refractive index of about 1.58 and the PCCD polymer has a refractive index of 1.51.

In another embodiment, a mixture of polycarbonate and a miscible oligomeric additive, such as resorcinol bis(diphenylphosphate) (RDP) is used, where the RDP has a refractive index of 1.56-1.57.

In yet another embodiment, a mixture of cycloaliphatic polyester to polycarbonate in the range of 80:20 to 5:95% by weight of the entire mixture is used. Blends from 70:30 to 40:60 are most preferred.

II. Discontinuous immiscible dispersed phase. The discontinuous immiscible dispersed phase constitutes domains of transparent thermoplastic polymers.

In one embodiment of the invention, the matrix thermoplastic resin is a polycarbonate having a R.I. of 1.55 to 1.59, the dispersed phase is transparent thermoplastic polymer, e.g., an acrylonitrile-butadiene-rubber (ABS), having a R.I. of 1.46 to 1.58.

In another embodiment, the dispersed phase comprises an amorphous impact modifier copolymer resin, which may comprise one of several different rubbery modifiers such as graft or core shell rubbers or combinations of two or more of these modifiers. Examples include the groups of modifiers known as acrylic rubbers, ASA rubbers, diene rubbers, organosiloxane rubbers, EPDM rubbers, SBS or SEBS rubbers, ABS rubbers, MBS rubbers and glycidyl ester impact modifiers. The term acrylic rubber modifier can refer to multi-stage, core-shell, interpolymer modifiers having a cross-linked or partially crosslinked (meth)acrylate rubbery core phase, preferably butyl acrylate. Associated with this cross-linked acrylic ester core is an outer shell of an acrylic or styrenic resin which interpenetrates the rubbery core phase. Incorporation of small amounts of other monomers such as acrylonitrile or (meth)acrylonitrile within the resin shell also provides suitable impact modifiers.

In one embodiment, the impact modifiers constituting the discontinuous phase include the group of polymers derived from vinyl cyanide monomers, di-olefins, vinyl aromatic monomers and vinyl carboxylic acid ester monomers as hereinafter defined.

Examples of vinyl cyanide monomers include acrylonitrile, methacrylonitrile, ethacrylonitrile, (-chloroacrylonitrile and (-bromoacrylonitrile. Examples of di-olefins include butadiene, isoprene, 1,3-heptadiene, methyl-1,3-pentadiene, 2,3-dimethylbutadiene, 2-ethyl-1,3-pentadiene, 1,3-hexadiene, 2,4-hexadiene, chlorobutadiene, bromobutadiene, dichlorobutadiene, dibromobutadiene and mixtures thereof. Examples of substituted vinyl aromatic monomers include styrene, 4-methylstyrene, vinyl xylene, 3,5-diethylstyrene, p-tert-butyl-styrene, 4-n-propyl styrene, (-methyl-styrene, (-ethyl-styrene, (-methyl-p-methylstyrene, p-hydroxy-styrene, methoxy-styrenes, chloro-styrene, 2-methyl-4-chloro-styrene, bromo-styrene, (-chloro-styrene, (-bromo-styrene, dichloro-styrene, 2,6-dichloro-4-methyl-styrene, dibromo-styrene, tetrachloro-styrene and mixtures thereof. Examples of vinyl carboxylic acid ester monomers include methyl methacrylate, methyl acrylate, ethyl methacrylate, ethyl acrylate, butyl methacrylate, butyl acrylate, propyl methacrylate, propyl acrylate, 2-ethylhexyl acrylate, 2-ethylhexyl methacrylate, methyl ethacrylate and mixtures thereof.

It will be understood that by the use of “monomers” are included all of the polymerizable species of monomers and copolymers typically utilized in polymerization reactions, including by way of example monomers, homopolymers of primarily a single monomer, copolymers of two or more monomers, terpolymers of three monomers and physical mixtures thereof. For example, a mixture of polymethylmethacrylate (PMMA) homopolymer and styrene-acrylonitrile (SAN) copolymer may be utilized to form the “free rigid phase”, or alternatively a methylmethacrylate-styrene-acrylonitrile (MMASAN) terpolymer may be utilized.

Various monomers may be further utilized in addition to or in place of those listed above to further modify various properties of the compositions disclosed herein. In general, the components of the present invention may be compounded with a copolymerizable monomer or monomers within a range not damaging the objectives and advantages of this invention. For example, in addition to or in place of SBR, the rubber phase may be comprised of polybutadiene, butadiene-acrylonitrile copolymers, polyisoprene, EPM and EPR rubbers (ethylene/propylene rubbers), EPDM rubbers (ethylene/propylene/non-conjugated diene rubbers) and crosslinked alkylacrylate rubbers based on C₁-C₈ alkylacrylates, in particular ethyl, butyl and ethylhexylacrylates, either alone or as a mixture of two or more kinds. Furthermore, the rubber may comprise either a block or random copolymer. In addition to or in place of styrene and acrylonitrile monomer used in the graft or free rigid phase, monomers including vinyl carboxylic acids such as acrylic acid, methacrylic acid and itaconic acid, acrylamides such as acrylamide, methacrylamide and n-butyl acrylamide, alpha-, beta-unsaturated dicarboxylic anhydrides such as maleic anhydride and itaconic anhydride, imides of alpha-, beta-unsaturated dicarboxylic acids such as maleimide, N-methylmaleimide, N-ethylmaleimide, N-Aryl maleimide and the halo substituted N-alkyl N-aryl maleimides, imidized polymethyl methacrylates (polyglutarimides), unsaturated ketones such as vinyl methyl ketone and methyl isopropenyl ketone, alpha-olefins such as ethylene and propylene, vinyl esters such as vinyl acetate and vinyl stearate, vinyl and vinylidene halides such as the vinyl and vinylidene chlorides and bromides, vinyl-substituted condensed aromatic ring structures such as vinyl naphthalene and vinyl anthracene and pyridine monomers may be used, either alone or as a mixture of two or more kinds.

The impact modifier is preferably based on a SBR high rubber graft with a SAN free rigid phase. Rubber amounts between about 20 percent and about 45 percent are preferred. This composition preferably comprises: a) a free rigid phase derived from a vinyl aromatic monomer and a vinyl carboxylic acid ester monomer, wherein the free rigid phase is present at a weight percent level of from about 30 to about 70 percent by weight based on the total weight of the composition, more preferably from about 35 to about 50 percent by weight thereof, and most preferably from about 38 to about 47 percent by weight thereof; b) a graft copolymer (graft phase) comprising a substrate copolymer and a superstrate copolymer wherein the substrate copolymer comprises a copolymer derived from a vinyl aromatic monomer and a di-olefin and wherein the superstrate copolymer comprises a copolymer derived from an aromatic monomer wherein the graft copolymer is present at a level of from about 30 to about 70 weight percent of the total weight of the composition, more preferably from about 50 to about 65 percent by weight thereof, and most preferably from about 53 to about 62 percent by weight thereof; and c) wherein the refractive index of the free rigid phase and the calculated refractive index of the graft phase are approximately the same (that is, matched to within about 0.005 or less).

The refractive index of the phases may be readily calculated based on the weight percentage of the components and their refractive indices, for example:
The refractive indices of butadiene, styrene, acrylonitrile and methyl methacrylate homo-polymers are 1.515, 1.591, 1.515 and 1.491 respectively. A butadiene/styrene ratio of 85:15 gives a calculated refractive index of (0.85×1.515)+(0.15×1.591)=˜1.526. The grafted SAN having a styrene to acrylonitrile ratio of 80:20 gives a calculated refractive index of (0.80×1.591)+(0.20×1.515)=˜1.576.

A graft copolymer of 65% styrene-butadiene rubber (butadiene styrene=85:15) and 35% grafted SAN (styrene: acrylonitrile=80:20) gives a calculated refractive index of (0.65×1.526)+(0.35×1.576)=˜1.544.

In the example above, the free rigid phase must have approximately the same refractive index as the graft rubber phase within ±0.005. A free rigid phase of 60% PMMA and 40 percent SAN of 75% styrene and 25% acrylonitrile has a refractive index of approximately 1.539, thereby matching the graft phase refractive index to within 0.005.

The free rigid phase is preferably derived from styrene-acrylonitrile (SAN). The ratio of styrene to acrylonitrile is preferably from 1.5 to 15 (that is, preferably from about 60 percent to about 94 percent styrene) and from about 6 percent to about 40 percent acrylonitrile by weight based on the total weight of the free rigid phase, more preferably from about 4 to 12 (from about 80 percent to about 92 percent styrene) and from about 8 percent to about 20 percent acrylonitrile by weight based on the total weight of the free rigid phase and most preferably from about 6 to 9 (from about 85 percent to about 90 percent styrene) and from about 10 percent to about 15 percent acrylonitrile by weight based on the total weight of the free rigid phase.

The graft copolymer is preferably derived from a vinyl aromatic-diolefin rubber substrate copolymer. The graft copolymer preferably comprises from about 40 percent to about 90 percent of a substrate copolymer and from about 10 percent to about 60 percent of a superstrate copolymer based on the total weight of the graft copolymer, more preferably from about 55 percent to about 75 percent of a substrate copolymer and from about 25 percent to 45 percent of a superstrate copolymer by weight thereof, and most preferably about 65 percent by weight of a substrate copolymer and 35 percent by weight of a superstrate copolymer.

The substrate copolymer preferably comprises a vinyl aromatic component level of from slightly greater than about 0 percent to about 30 percent by weight based on the total weight of the substrate copolymer, more preferably from 10 to 20 percent by weight thereof and most preferably 15 percent by weight thereof, and a di-olefin component level of from about 70 percent to about 100 percent of a di-olefin by weight based on the total weight of the substrate copolymer, more preferably from about 80 to about 90 percent by weight thereof, and most preferably about 85 percent by weight thereof.

The superstrate may optionally contain a vinyl carboxylic acid ester component such as methyl methacrylate. The graft phase preferably has a weight average particle size of less than 2400 angstroms (0.24 microns), more preferably less than 1600 angstroms (0.16 microns) and most preferably less than 1200 angstroms (0.12 microns). Generally, the particle size of the rubber has an effect upon the optimum grafting level for the graft copolymer. As a given weight percentage of smaller size rubber particles will provide greater surface area for grafting than the equivalent weight of a larger rubber particle size, the density of grafting may be varied accordingly. In general, smaller rubber particles preferably utilize a higher superstrate/substrate ratio than larger size particles to give generally comparable results.

The graft phase may be coagulated, blended and collided with the free rigid phase homopolymers, copolymers and/or terpolymers by the various blending processes that are well known in the art to form the polyblend.

In one embodiment, the dispersed phase is a two-phase ABS system, with the first phase comprising a high rubber styrene-butadiene rubber (SBR) graft phase with a copolymer of styrene-acrylonitrile (SAN) attached to it, and a second phase or the rigid phase comprises methyl methacrylate in the form of polymethylmethacrylate (PMMA) and SAN and is commonly referred to as the “free rigid phase.” The SBR/SAN graft phase is dispersed throughout the rigid phase PMMA/SAN that forms the polymer continuum. The rubber interface is the surface forming the boundaries between the graft and rigid phases. The grafted SAN acts as a compatibilizer between the rubber and rigid phase at this interface and prevents the separation of these two otherwise immiscible phases.

In another embodiment, the dispersed phase is a MBS comprising a) from about 25 to about 75 wt. % of styrenic monomer selected from the group consisting of styrene, p-methyl styrene, tertiary butyl styrene, dimethyl styrene, and the nuclear brominated or chlorinated derivatives thereof; b) about 7 to 30 wt. % of butyl acrylate; c) about 10 to 50 wt. % of methyl methacrylate; and d) from about 2 to about 20 of a block copolymer selected from the group consisting of di-block and tri-block copolymers of styrene-butadiene, styrene-butadiene-styrene, styrene-isoprene, styrene-isoprene-styrene, partially hydrogenated styrene-butadiene-styrene and partially hydrogenated styrene-isoprene-styrene linear or radial block copolymers with a molecular weight of less than about 75,000.

In one embodiment of MBS as the dispersed phase, the MBS is a transparent material prepared by a bulk polymerization process, available from NOVA Chemicals under the trade name ZYLAR, having a higher level of RI as compared to other dispersed phase transparent materials containing butadiene. Said bulk MBS has a unique morphology by utilizing block styrene butadiene rubber as the source of rubber. In another embodiment, the amount of bulk MBS is present in an amount of at least 0.1 wt. % of the total weight of the thermoplastic composition. In a preferred embodiment, this amount is about 2 to 20 wt. %. In a most preferred embodiment, the amount is about 4 to 10 wt. %.

In another embodiment of the dispersed phase wherein SAN is used, the refractive index of the SAN phase is adjusted (increased). This is done by decreasing the amount of acrylonitrile nitrile in the styrene acrylonitrile polymer. In other words, increasing the styrene content of the styrene acrylonitrile copolymer increases the refractive index of the copolymer. In contrast use of methyl methylmethacrylate as a co-monomer generally decreases the refractive index. Thus, depending on whether the refractive index of a copolymer is to be increased or decreased, the choice of the co-monomer can be made.

In one embodiment of the disperse phase, impact modifiers are of the type disclosed in U.S. Pat. No. 4,292,233, incorporated by reference, are used. These impact modifiers comprise, generally, a relatively high content of a cross-linked butadiene polymer grafted base having grafted thereon acrylonitrile and styrene.

In another embodiment, the rubbers rubbers are graft or core shell structures with a rubbery component with a Tg below 0° C., preferably between about −400 to −80° C., composed of poly alkylacrylates or polyolefins grafted with PMMA or SAN. Preferably the rubber content is at least 40 wt %, most preferably between about 60-90 wt %. In yet another embodiment, the rubbers are the butadiene core-shell polymers of the type available from Rohm & Haas, for example Paraloid®) EXL2600. In some embodiments, the impact modifier will comprise a two stage polymer having an butadiene based rubbery core and a second stage polymerized from methylmethacrylate alone or in combination with styrene. Other suitable rubbers are the ABS types Blendex® 336 and 415, available from GE Specialty Chemicals. Both rubbers are based on impact modifier resin of SBR rubber. Although the mentioned rubbers appear to be very suitable as the dispersed phase, there are many more rubbers which can be used. In one embodiment, the rubbers have RI between 1.51 and 1.58 which has a reasonable clarity.

In another embodiment, the dispersed phase comprises MBS/ABS type of rubbers with a particle size range from 50-1000 nm, the rubber being butadiene or styrene-butadiene with styrene content of up to 40%. Styrene to acrylonitrile ratio in ABS rubbers can be between 100/0 and 50/50 with a preferred ratio of 80/20 to 70/30. Typical examples are ABS 415 (RI=1.542) and ABS 336 (RI=1.546), both produced by GE Plastics and BTA702, BTA736, being MBS materials and produced by Rohm & Haas. All these rubbers are used in the PVC market as impact modifiers to improve the toughness of PVC without loosing the transparency.

Surprisingly, with opaque impact modifiers like MBS EXL2600, produced by Rohm & Haas, the effect of adding PCCD to these PC/impact modifier compositions had very similar results; high transmissions and low haze values were obtained with modifiers, each modifier having an unique PC/PCCD ratio to match the RI.

In yet another embodiment for a clear impact modified PC blend, the use of a high rubber graft ABS resin and PMMA is used to make a reasonable clear product. All these resins have SAN (styrene-acrylonitrile co-polymer) graft and PMMA can be used to lower the RI of the graft and free SAN to match the matrix RI, being PC/PCCD.

III. Matching the RI for the composition of the present invention. The transparency or translucency of the resulting composition of the present invention, as well as the haze measurement will depend on whether the “dispersed phase” has a refractive index that matches or approximates that of the continuous phase.

The term matching of refractive indexes is functionally defined herein that when two or more immiscible phases constitute a mixture, their respective refractive indices are said to be matched, if the resulting mixture is transparent. For example, when the refractive indices of the continuous phase or matrix comprising polycarbonate matches the refractive index of the dispersed phase comprising ABS the alloy is usually transparent.

When there is less of a match in the refractive indices of the two phases the alloy is translucent, i.e., the particles of polymer comprising the dispersed phase (i.e. the discontinuous phase) will have a refractive index different from that of the matrix or continuous phase. For a given level of mis-match in refractive indices for the two phases the haze level may be increased by increasing the loading or weight percent fraction of the dispersed phase in the continuous phase. As the mis-match in refractive indices becomes greater the loading of the disperse phase necessary to achieve a given level of translucency or haze is reduced.

Functionally, a translucent composition utilizing the compositions and processes of the present invention is one that is less than transparent but not opaque. Thus both the transparent and translucent alloys of the present invention may be described as non-opaque, whether filled or unfilled.

In one embodiment wherein transparency is desired, a dispersed phase comprising ABS that has a refractive index close to that of the polycarbonate matrix is prepared. Polycarbonate has a R.I. of 1.55 to 1.59, and acrylonitrile-butadiene-rubber (ABS) has a R.I. of 1.46 to 1.58. This means that the R.I. of the ABS must be increased, or that of the polycarbonate must be lowered.

For translucent compositions the haze as measured by ASTM-9125 ranges from about 100 to about 0, preferably from about 90 to about 3, more preferably from about 70 to about 5, and most preferably from about 50 to about 10.

In an embodiment of transparent and translucent alloys of a continuous phase comprising polycarbonate and a discontinuous phase comprising ABS, the weight percent of the polycarbonate phase ranges from about 95 to about 50, preferably from about 90 to about 55, more preferably from about 85 to about 65, and most preferably from about 80 to about 70 weight percent of the sum of the weight percents of the continuous and discontinuous phases.

IV. Optional components. In one embodiment, the optional components are include phosphorescent pigments, a fluorescent dye, liquid crystals, metallic type pigments, e.g., rectangular aluminum flakes as disclosed in WO 99/02594, for various visual appearances including angular metamerism effect depending on the visual effect components used. For most visual effects, it is desirable to have a complete transparent matrix in order to obtain the deepest color effect. It should be noted that the use of metal flakes result in a very bright, metallic reflective sparkle appearance in the molded articles while retaining impact strength and transparency. Furthermore, adding an optical brightening agent helps produce a brighter color for the article. Suitable optical brightening agents include aromatic stilbene derivatives, aromatic benzoxazole derivatives, or aromatic stilbene benzoxazole derivatives. Among these optical brightening agents, Uvitex OB from Ciba Specialty Chemicals (2,5-bis(5′-tert-butyl-2-benzoxazolyl)thiophene) is preferred.

In one example for a composition with striking visual effects for the article molded thereof, a fluorescent dyestuff is added. Suitable fluorescent dyestuffs include Permanent Pink R (Color Index Pigment Red 181, from Clariant Corporation), Hostasol Red 5B (Color Index #73300, CAS # 522-75-8, from Clariant Corporation) and Macrolex Fluorescent Yellow 10GN (Color Index Solvent Yellow 160:1, from Bayer Corporation). Among these, Permanent Pink R is preferred.

Examples of pigment well known for inclusion in thermoplastic materials can also be added to the thermoplastic matrix. Preferred pigments include titanium dioxide, zinc sulfide, carbon black, cobalt chromate, cobalt titanate, cadmium sulfides, iron oxide, sodium aluminum sulfosilicate, sodium sulfosilicate, chrome antimony titanium rutile, nickel antimony titanium rutile, zinc oxide, and polytetrafluoroethylene.

In one embodiment of the invention, a combination of tin oxide and fiberglass is used to achieve a “diamond” effect in the finished article. In other embodiments, PMMA is used for a diffusion effect; mica is used for pearlescent effect; A1 flakes are used for a metallic effect.

The use of modifiers in combination various visual effect/colorant additives in thermoplastic compositions is known to be detrimental to physical properties such as notched Izod impact. Although various impact modifiers are known in the prior art, the prior art is deficient in addressing the problem of enhancing the impact properties of polycarbonate (alloys) having special effect colorants, while maintaining the transparency. Applicants have found that the blend compositions of the present invention combine appealing aesthetics, chemical resistance, and high impact properties and will be useful in molded article applications where this combination of property is desirable.

In another embodiment, additives such as reinforcing agents, fillers, impact modifiers, heat resisting agents, nucleating agents, anti-weathering agents, plasticizers, flame retardants, flow-improving agents, stabilizers, mold release agents, and anti-statics antioxidants, flow aids, drip suppressants, quenchers, minerals such as talc, clay, mica, barite, wollastonite and other stabilizers including but not limited to UV stabilizers, such as benzotriazole, supplemental reinforcing fillers such as flaked or milled glass, and the like, flame retardants, pigments or combinations thereof may be added to the compositions of the present invention. These additives may be introduced in a mixing or molding process, provided the properties of the composition are not damaged.

Examples of optional lubricants and release agents are ethylene bis stearamide, ethylenediamine bis stearamide, butyl stearate, barium stearate, calcium stearate, calcium behenate, calcium laurate, zinc stearate, zinc laurate, aluminum stearate, magnesium stearate, glycerin, mineral oils, liquid paraffins, waxes, higher fatty amides, lower alcohol esters of higher fatty acids, polyvalent alcohol esters of fatty acids and silicone based mold release agents. Other examples of mold release agents include, but are not limited to, pentaerythritol tetracarboxylate, glycerol monocarboxylates, glycerol tricarboxylates, polyolefins. Suitable antistatic agents include, but are not limited to, phosphonium salts, polyalkylene glycols, sulfonium salts and alkyl and aryl ammonium salts. Examples of stabilizers or antioxidants include phosphites (e.g., aromatic phosphite thermal stabilizers), metal salts of phosphoric and phosphorous acid, hindered phenol antioxidants, and aromatic lactone radical scavengers.

Examples of reinforcing fillers may be metallic fillers such as fine powder aluminum, iron, nickel, or metal oxides. Non-metallic fillers include carbon filaments, silicates such as mica, aluminum silicate or clay, talc and asbestos, titanium oxide, wollastonite, novaculite, potassium titanate, titanate whiskers, glass fillers and polymer fibers or combinations thereof. Glass fillers useful for reinforcement when used as reinforcing agents are not particularly limited in their types or shapes and may be, for instance, glass fibers, milled glass, glass flakes and hollow or solid glass beads. Glass fillers may be subjected to surface treatment with coupling agents such as silane or titanate-type agents to enhance their adhesion with resin, or coated with inorganic oxides to provide some surface color to the filler. Other types of glass filler may be used to impart decorative effects or special optical effects to the finished articles and may or may not also simultaneously function as reinforcing fillers.

Reinforcing fillers are preferably used in an amount sufficient to yield the reinforcing effect, usually 1 to 60% by weight, preferably less than 10% by weight, based on the total weight of the composition. Glass fibers, or a combination of glass fibers with talc, mica or aluminum silicate are preferred reinforcing agents. These fibers are preferably about 0.00012 to 0.00075 inches long. Unless the filler has optical properties that are complementary to that of thermoplastic composition being filled, e.g. such as a close match in RI, the amount of filler added must be less than that which would make the material opaque.

In yet another embodiment, wherein the composition contains a cycloaliphatic polyester resin and a polycarbonate resin, a stabilizer or quencher material is used. Catalyst quenchers are agents which inhibit activity of any catalysts which may be present in the resins. Catalyst quenchers are described in detail in U.S. Pat. No. 5,441,997. It is desirable to select the correct quencher to avoid color formation and loss of clarity to the polyester polycarbonate blend.

A preferred class of stabilizers including quenchers are those which provide a transparent and colorless product. Typically, such stabilizers are used at a level of 0.001-10 weight percent and preferably at a level of from 0.005-2 weight percent.

The most preferred quenchers are oxo acids of phosphorus or acidic organo phosphorus compounds. Inorganic acidic phosphorus compounds may also be used as quenchers, however they may result in haze or loss of clarity. Most preferred quenchers are phosphoric acid, phosphorous acid or their partial esters.

The favored stabilizers include an effective amount of an acidic phosphate salt; an acid, alkyl, aryl or mixed phosphite having at least one acidic hydrogen; a Group IB or Group IIB metal phosphate salt; a phosphorus oxo acid, a metal acid pyrophosphate or a mixture thereof. The suitability of a particular compound for use as a stabilizer and the determination of how much is to be used as a stabilizer may be readily determined by preparing a mixture of the polyester resin component and the polycarbonate and determining the effect on melt viscosity, gas generation or color stability or the formation of interpolymer. The acidic phosphate salts include sodium dihydrogen phosphate, mono zinc phosphate, potassium hydrogen phosphate, calcium dihydrogen phosphate and the like.

The phosphate salts of a Group IB or Group IIB metal include zinc phosphate and the like. The phosphorus oxo acids include phosphorous acid, phosphoric acid, polyphosphoric acid or hypophosphorous acid.

The polyacid pyrophosphates may be of the formula MzxHyPnO3n+1, wherein M is a metal, x is a number ranging from 1 to 12 and y is a number ranging 1 to 12, n is a number from 2 to 10, z is a number from 1 to 5 and the sum of (xz)+y is equal to n+2. The preferred M is an alkaline or alkaline earth metal.

In one embodiment of the invention, a polycarbonate derived from brominated bisphenol is added as a flame retardant. When such brominated polymers are added, inorganic or organic antimony compounds may further be blended in the composition to synergistically enhance flame retardance introduced by such polycarbonate. Suitable inorganic antimony compounds are antimony oxide, antimony phosphate, KSb(OH)₆, NH₄SbF₆ and Sb₂S₃. A wide variety of organic antimony compounds may also be used, such as antimonic esters of organic acids, cyclic alkyl antimonite esters and aryl antimonic acid compounds. Examples of typical organic antimony compounds are potassium antimony tartrate, antimony salt of caproic acid, Sb(OCH₂CH₃)₃, Sb(OCH(CH₃)CH₂CH₃)₃, antimony polymethylene glycorate and triphenyl antimony. A preferred antimony compound is antimony oxide.

V. Preparation. The method of blending the compositions can be carried out by conventional techniques. To prepare the resin composition of the invention, the components may be mixed by any known methods. Typically, there are two distinct mixing steps: a premixing step and a melt-mixing step. In the premixing step, the dry ingredients are mixed together. This premixing step is typically performed using a tumbler mixer or a ribbon blender. However, if desired, the premix may be manufactured using a high shear mixer such as a Henschel mixer or similar high intensity device. The premixing step must be followed by a melt-mixing step where the premix is melted and mixed again as a melt. Alternatively, it is possible to skip the premixing step, and simply add the raw materials directly into the feed section of a melt mixing device via separate feed systems. In the melt mixing step, the ingredients are typically melt kneaded in a single screw or twin screw extruder, a Banbury mixer, a two roll mill, or similar device.

In one embodiment, polyester and polycarbonate are pre-blended in an amount selected to match the refractive index of the modifier. The ingredients are typically in powder or granular form, extruding the blend and comminuting into pellets or other suitable shapes. The ingredients are next combined in any usual manner, e.g., by dry mixing or by mixing in the melted state in an extruder, or in other mixers.

The composition according to present invention may then be formed into articles by any known method such as extrusion or injection molding. For example, the composition may be may be used to prepare film sheet or complex shapes via any conventional technique.

The thermoplastic articles according to the present invention are useful for a variety of different purposes. As some specific, non-limiting examples, they may be used for business equipment housings such as computer, monitor or printer housings, communications equipment housings such as cellular phone enclosures, data storage device housings, appliances, or automobile parts such as instrument panel components or in a lens for a headlamp. The article can be any size or shape. Thermoplastic articles according to the invention are particularly preferred for applications where low clarity and high percent light transmission are design objectives.

As discussed above, by combining a styrene-butadiene rubber/styrene-acrylonitrile (SBR/SAN) high rubber graft phase with a rigid matrix phase derived from methyl methacrylate, styrene and acrylonitrile wherein the calculated refractive index of the graft phase approximately matches the refractive index of the matrix phase, low haze extrudable transparent polymers having the ductility and performance advantages may be prepared. In one embodiment, the thermoplastic compositions of the present invention are extruded into thin films with rubbery charactership, ductility, and good adhesion to other polymers, providing a lower cost approach to preparation of items such as bulletproof polymer laminates.

In addition to the improved properties such as improved tensile impact and chemical resistance among others, there are manufacturing advantages as well for cold forming operatings. The low Tg of the material enables the operator to use lower temperatures to thermoform the film. These products will perfectly suit in applications like eg. transparent keypads for mobile phones, where customers require the possibility to form these films at low temperatures (below 100° C.) and further require an improved punch ductility and chemical resistance. Other typical applications of such films are automotive trim, automotive interior parts, portable telecommunications and appliance fronts.

In applications wherein visual effects are required, visual effects pigments (such as coated A1 and glass flakes) can be added. These pigments can be added to the blends of the present invention without the normal negative impact to mechanical properties of as typically seen with polycarbonate compositions. The films can be used in direct film applications but also in processes like IMD (In Mould Decoration).

The preferred impact-modified, cycloaliphatic polymer compositions of the present invention comprise:

(A) from 20 to 80% by weight of a blend of polycarbonate and cyclo aliphatic polyester resin, where the ratio of polycarbonate to cyclo aliphatic polyester resin is from 20/80 to 95/5, preferable from 30/70 to 60/40, the cyclo aliphatic polyester comprises the reaction product of:
(a) at least one straight chain, branched, or cycloaliphatic C₂-C₁₂ alkane diol, most preferably a C₆-C₁₂ cycloaliphatic diol, or chemical equivalent thereof; and
(b) at least one cycloaliphatic diacid, most preferably a C₆-C₁₂ diacid, or chemical equivalent thereof; and

(B) from 1 to 30%, preferably from 5 to 20% by weight of an impact modifier comprising a substantially amorphous resin comprising one of several different modifiers or combinations of two or more of these modifiers. Suitable are the groups of modifiers known as ABS modifiers ASA modifiers, MBS modifiers, EPDM graft SAN modifiers, acrylic rubber modifiers.

Impact modified polycarbonate resins as outlined above are excellent materials for applications requiring high impact, chemical resistance, and appealing aesthetic. In order to improve the appearance, special effect additives have been utilized as colorants. U.S. Pat. No. 5,510,398 to Clark et al relates to a highly filled, extruded polyalkylene terephthalate resin, a polycarbonate resin, a filler, a stabilizer, and a non-dispersing pigment to give the extruded thermoplastic material a speckled surface appearance. Column 5, lines 35 to column 6, line 61, describes impact modifiers. U.S. Pat. No. 5,441,997 to Walsh et al describes the use of impact modifiers in conjunction with polycarbonate/polyester compositions having a barium sulfate, strontium sulfate, zirconium oxide, or zinc sulfate filler. U.S. Pat. No. 5,814,712 to Gallucci et al describes a glycidyl ester as an impact modifier, and optionally other impact modifiers, for a polycarbonate/polyester resin. U.S. Pat. No. 4,264,487 to Fromuth et al describes aromatic polycarbonate, acrylate-based core-shell polymer, and aromatic polyester.

The glass transition temperature of the preferred blend will be from 60 to 150° C. with the range of 90-150° C. most preferred.

A flexural modulus (as measured by ASTM method D790) at room temperature of greater than or equal to 150,00 psi is preferred, with a flexural modulus of greater than or equal to 250,000 psi being more preferred.

The yellowness index (YI) will be less than 10, preferably less than 5 as measured by ASTM method D1925.

Haze, as measured by ASTM method D1003, will be below 5% in the preferred composition, however in some cases higher haze levels (5-60%) are preferred in cases where the highest heat resistance is needed.

### EXAMPLES

The present invention is further illustrated by way of the following examples. These examples are intended to be representative of the invention and are not in any way intended to limit its scope.

In all examples, unless specified otherwise, blends were prepared by tumbling all ingredients together for 1-5 min at room temperature followed by extrusion at 250-300° C. on a co-rotating 30 mm vacuum vented twin screw extruder. Blends were run at 300 rpm. The output was cooled as a strand in a water bath and pelletized. The resultant materials were dried at 100-120° C. for 3-6 h and injection molded in discs or sections of discs (fans) for evaluation of optical properties.

### Example 1

| | | | | | | | | MVR | |
|---|---|---|---|---|---|---|---|---|---|
| | | PCCD | | | | | | (cc/10′) | |
| | PC 105 | 4000 | stabilizers | Impact | | PC/PCCD | Transmission | (300° C. | D/B |
| Batch # | Grade % | Poise % | % | Modifier % | | ratio | 2 mm | 1. kg) | ° C. |
| 1 | 99.8 | | 0.2 | | | | 91.4 | 5.1 | −10 |
| 2 | 69.6 | 30 | 0.4 | | | 70/30 | 90.4 | 16.8 | 0 |
| 3 | 28.4 | 66.2 | 0.4 | 5% | MBS | 30/70 | 89.5 | 31.6 | −20 |
| 4 | 25.4 | 59.2 | 0.4 | 15% | MBS | 30/70 | 88.5 | 14.3 | −32 |
| 5 | 30.6 | 54 | 0.4 | 15% | clear ABS | 36/64 | 89.6 | 22.2 | −6 |
| 6 | 47.3 | 47.3 | 0.4 | 10% | ABS 415 | 50/50 | 89.8 | 7.4 | −22 |
| 7 | 46.6 | 38.1 | 0.4 | 15% | ABS 336 | 45/50 | 88.1 | 6.7 | −33 |
| 8 | 67.2 | 22.4 | 0.4 | 10% | ABS 336 | 25/75 | 77.1 | 4.8 | −32 |

From the data batch 1-7, it is clear that adding PCCD to PC gives a significant improvement in flow. Besides the improvement in flow, but there is also improvement in low temperature ductility, while obtaining high transparencies in the same range as PC. It should be noted that in some cases, lower amounts of the miscible additive PCCD than the ones mentioned in batch 2-7 are desired from a cost perspective, or that for some applications more heat is required. Although this will result in lower transmission values (the 100% match of RI is no longer present in the blend), other properties are still high enough to allow for adding special/visual effects like glass or metal flakes. In some cases some translucency is even desired as with batch 8 in the table.

### Example 2

The property enhancement characteristics of the present invention are further illustrated in the next table, in which comparisons are made between PC formulated with special effects and blends of PC/PCCD and impact modifier as the dispersed phase, formulated with the same type of special effects.

| | | | | | | MVR | |
|---|---|---|---|---|---|---|---|
| | PC105 | PCCD2000 | | Impact | | (cc/10′) | D/B |
| Batch # | grade % | poise % | Stabilizers % | Modifier % | Special Effect | (265° C.5 kg) | ° C. |
| 9 | 98.3 | 0 | 0.5 | | 1.2% glass/silver flakes | 10.1 | >25 |
| 10 | 41.7 | 41.7 | 0.4 | 15% ABS 415 | 1.2% glass/silver flakes | 12.8 | −22 |
| 11 | 99.3 | 0 | 0.5 | | 0.2% variochr. red | 10.4 | >25 |
| | | | | | (AngularMetameric) | | |
| 12 | 41.7 | 41.7 | 0.4 | 15% ABS 415 | 0.2% variochr. red | 12.8 | −18 |
| | | | | | (AngularMetameric) | | |

It is obvious from the data that typical effects like glass and metal flakes turn PC into very brittle blends. However with the additives of the present invention, e.g., PCCD, and the impact modifier, the visual effect was very similar to the PC sample, but the blend was still ductile at lower than 0° C. and even had an improved flow. This remarkable achievement of highly ductile, transparent materials with special effects like Angular Metamerism, Diamond, Diffusion and Pearl effects is not restricted to the ones mentioned in the examples.

### Example 3

Film material with a thickness of 220 microns was produced from a 45/45/10% ratio PC/PCCD/ABS blend and tested with 100% PC film as a reference material. Obtained results are as shown below:

| | Film | Film sample 2 | Film sample 3 |
|---|---|---|---|
| | sample 1 | 45/45/10% | 40/60% |
| Test name: | 100% PC | PC/PCCD/ABS | PC/PCCD |
| Tensile Impact | 961 | 1129 | 1147 |
| Kj/m2 | 75.2 | 98.3 | 87.5 |
| Elongation | | | |
| to br. % | | | |
| After stress | 102.8 | 126.4 | 154.6 |
| cracking | | | |
| “sweat” test: | | | |
| Tensile Strain | | | |
| at max % | | | |
| Taber Abrasion | 27 | 24 | 19 |
| ASTM | | | |
| D1044 25 | | | |
| Rotations | | | |
| Haze % | | | |

Example 3 shows that impact properties of film material made from PC/PCCD mixtures is improved significantly compared to PC alone, either with or without adding impact modifiers. Also the chemical resistance towards artificial sweat has improved.

### Example 4

In this example, mixtures of PC and SAN with different AN content were prepared: PC/SAN1 (AN 25%), PC/SAN2 (AN 20%) and PC SAN3 (AN15%). In this series PC/SAN1 is the comparative mix.

The mixtures were prepared using the following formulation: 75 parts of PC (1×105), 0.25 parts PETS (obtained from Henkel), 0.1 parts antioxidant 1076 (obtained from CIBA) and 0.1 part tris (di-tert butylphenyl-phosphite (obtained from Ciba Geigy and 25 parts of the various SAN's. The samples were compounded on a twin-screw extruder and injection-molded at standard conditions with the results of the analysis are shown below.

| | PC/SAN1 | PC/SAN2 | PC/SAN3 |
|---|---|---|---|
| Transmission (%, 3.2 mm) | 50.2 | 60.1 | 69.7 |
| Haze (ASTM-9125) | 97.5 | 81.3 | 70.5 |
| FPI (0° C., N, ISO | 2835 | 9507 | 2117 |
| 6603/2) | | | |
| INI (23° C., Kj/m², | 5.9 | 5.8 | 4.9 |
| ISO 180) | | | |
| Tensile Modulus (Mpa, | 2722 | 2785 | 2780 |
| ISO 527) | | | |
| Vicat B (ISO 306/B) | 129.6 | 134.4 | 124.1 |

As shown above, when the RI of the SAN phase is increased, the difference between the R.I. of the PC and the SAN phases decreases. This results in an increase of the transparency of the blend and a decrease of the haze.

### Example 5

In example 5, mixtures of PC/SAN3/impact modifier (IM) were prepared: PC/SAN3/IM1, PC/SAN3/IM2, PC/SAN/IM3.1M1 and IM2 are impact modifiers from UBE Cycon, or Blendex336 as obtained from GE Specialty Chemicals. The mixtures were prepared using the following formulation: 65 parts of PC (1×105), 20 parts of SAN3 (obtained from GE Plastics Bauvais), 0.25 parts PETS (obtained from Henkel), 0.1 parts antioxidant 1076 (obtained from CIBA) and 0.1 part tris (di-tert butylphenyl-phosphite (obtained from Ciba Geigy), and 25 parts of the various SAN's. The samples were compounded on a twin-screw extruder and injection-molded at standard conditions. The results of the analysis of the molded samples are presented below.

| | PC/SAN3/ | PC/SAN3/ | PC/SAN3/ |
|---|---|---|---|
| | IM1 | IM2 | IM3 |
| Transmission | 16.6 | 36.7 | 70.5 |
| (%, 3.2 mm) | | | |
| Haze (ASTM9125) | 100 | 100 | 94.7 |
| FPI (0° C., | 7656 | 7778 | |
| N, ISO 6603/2) | | | |
| INI (23° C., | 70.7 | 67 | 7.8 |
| Kj/m², ISO 180) | | | |
| Tensile Modulus | 2189 | 2172 | 2477 |
| (Mpa, ISO527) | | | |
| Vicat B | 100.3 | 100.5 | 94.7 |
| (ISO 306/B) | | | |

The use of various rubber types in the optimal PC/SAN blends of example 1 results in differences of transmission. Impact modifier IM3 gives no reduction of transmission compared to the PC/SAN3 blend of example 3 but a small increase in haze.

### Example 6

Prior to compounding in example 6, the following pigments were added to the mixtures PC/SAN3/IM2 and PC/SAN3/IM3 described above: 0.03 parts macrolex voilet 3R (obtained from Bayer), 0.16 parts solvet blue 97 (RMC126, macrolex blue RR, obtained from Bayer), 0.5 parts aluminum flake RMC 916 (obtained from Geotech) and 0.2 parts glassflake (obtained from Engelhart). The mixtures were compounded and injection molded using standard conditions and evaluated on appearance in comparison to a pure PC with the same pigment mixture.

The PC/SAN3/IM2 sample was evaluated as having a lighter color (due to the opaqueness of the matrix) and showing less ‘depth’ effect than the Pure PC sample. The PC/SAN3/IM3 sample however, showed the same color and ‘depth of effect’ as was observed with the pure PC sample. Comparison of complete color formulations containing special effect pigments prepared from the two best PC/SAN/IM blends (with IM2 and IM3) with a similar formulation in pure PC shows that a PC/SAN/IM blend with transmission of 70% or higher results in the same depth of effect as is obtained from pure PC.

### Example 7

In batch A, a mixture of 75 parts of PC—SP dodecane-PC copolymer, 25 parts of SAN (SAN (suspension SAN, 15% AN, prepared in VSS), 0.25 parts PETS (obtained from Henkel), 0.1 parts antioxidant 1076 (obtained from CIBA) and 0.1 part tris (di-tertbutylphenyl-phosphite (obtained from Ciba Geigy) was extruded through a twin screw extruder. The resulting pellets were molded into plastic parts with a thickness of 3.2 mm.

For comparison purpose, batch B was prepared. The mixture of PC and SAN (AN=15%) content was prepared using the following formulation: 75 parts of PC (1×105), 0.25 parts PETS (obtained from Henkel), 0.1 parts antioxidant 1076 (obtained from CIBA) and 0.1 part tris (di-tert butylphenyl-phosphite (obtained from Ciba Geigy and 25 parts of the various SAN (obtained from GEP-VSS). The sample were compounded on a twin-screw extruder and injection-molded into plaques with a thickness of 3.2 mm at standard conditions. The results of the analysis of the molded samples of the two batches A and B are presented below.

| | Batch A | Batch B |
|---|---|---|
| Transmission (%, 3.2 mm) | 81 | 69.7 |
| Haze (ASTM - 9125) | 37 | 70.5 |

### Example 8

In this example, PCCD with low RI (RI of PCCD 1.516) that is fully miscible with PC is used to lower the RI of the PC phase (phase 1) to the RI of a clear ABS (that has RI of SAN and Rubber phases already matched). This results in transparent PC/SAN/rubber blend. Mixtures of PC/PCCD resulted in linear RI going from 1.525 to 1.577 when using 100% PCCD to 100% PC respectively. The clear ABS that was utilized in this example had a RI of 1.548. In order to match this a PC/PCCD ratio of 54 to 31 was prepared and mixed with 15 wt. % of clear ABS. The results of samples from this blend are presented below.

| | ExC |
|---|---|
| Transmission (%, 3.2 mm) | 85 |
| Haze (ASTM9125) | 15 |

The refractive index of pure polycarbonate (PC) is 1.586 while that of PCCD is 1.516. In a mixture of polycarbonate and PCCD, the refractive index of the mixture, y is estimated to vary as the function −0.0007 (weight percent poly(1,4-cyclohexanedimethanol-1,4-cyclohexanedicarboxylate)+1.586 with a regression R squared coefficient of 0.998. Thus the refractive index of the mixture of the two components may be controlled between the upper and lower limits of their respective indices of refraction.

### Example 9

This example is a calculated example using a mixture of polycarbonate having a refractive index of 1.586 and resorcinol diphosphate (RDP) having a refractive index of 1.5673. A mixture having 25 weight percent RDP in PC would result in a calculate refractive index of 0.25(1.5673)+0.75(1.586)=1.581.

The examples show that the addition of the additives of the present invention, e.g., PCCD or RDP lowers the RI of PC comprising either of these two additional components. In the embodiments with PCCD, PCCD can be used to lower the RI of the PC phase to match the RI of the SAN/rubber phase resulting in a transparent impact modified PC alloy.

### Example 10

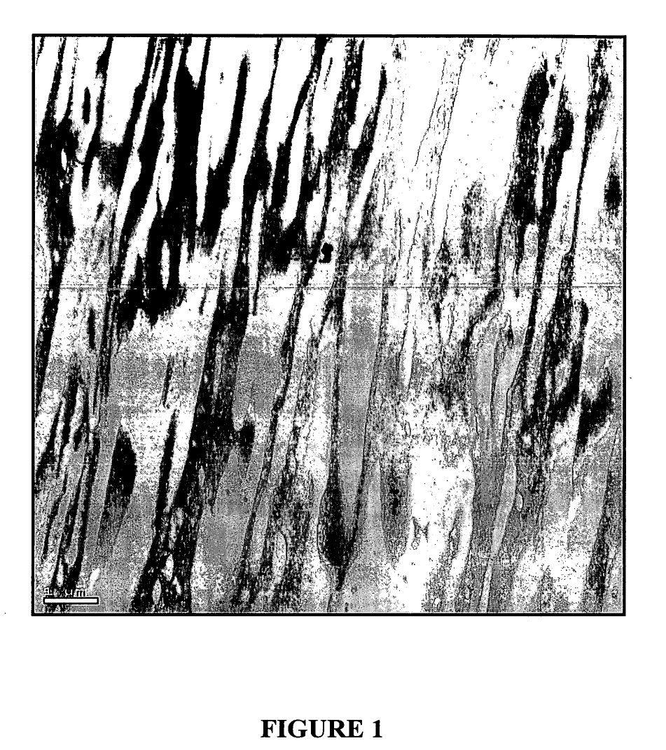

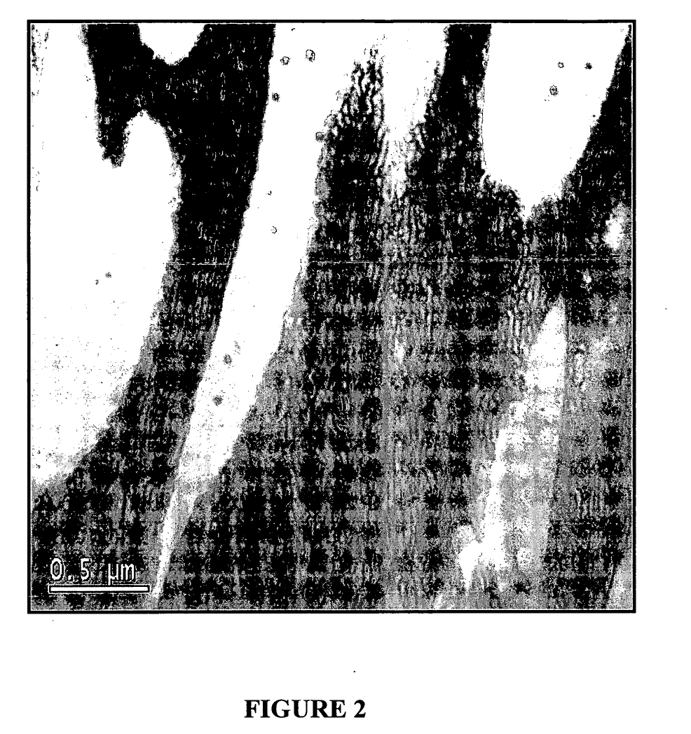

In this example, the polycarbonate is available from General Electric Company under the trade name PC 105. The dispersed phase is a bulk MBS from NOVA under the trade name Zylar 93-546B, having a unique morphology as shown in FIGS. 1 and 2 by the use of block styrene butadiene rubber as the source of rubber, as shown in the TEM. The morphology allows the dispersed phase to have a higher refractive index relative to other transparent materials that contain butadiene. With the higher RI, less amount of the miscible additive, e.g., PCCD, can be used. The end result is lower cost, and more importantly, a higher heat deflection temperature (HDT), lower haze, and lower yellow index (YI). SAN 581 is a styrene acrylonitrile copolymer from General Electric Company with a S/AN ratio of 75/25. The stabilizers used in the runs of this example include F618, a phosphite stabilizer from GE Specialty Chemicals. F207 is PEP-Q is also a phosphorous containing stabilizer.

| | MATERIAL | | | | | | |
|---|---|---|---|---|---|---|---|
| | 1 | 2 | 3 | 4 | 5 | 6 | 7 |
| building blocks | Parts | Parts | Parts | Parts | Parts | Parts | Parts |
| PCCD | 21.62 | 16.45 | 18.8 | 18.8 | 18.8 | 18.8 | 18.24 |
| PC 105 | 70.38 | 53.55 | 61.2 | 61.2 | 61.2 | 61.2 | 61.76 |
| Zylar 93 546B | 8 | 30 | 8 | 6 | 4 | 2 | |
| 581 SAN | | | 12 | 14 | 16 | 18 | 20 |
| Additives | | | | | | | |
| F207 | 0.2 | 0.2 | 0.2 | 0.2 | 0.2 | 0.2 | 0.15 |
| F174 | 0.05 | 0.05 | | | | | 0.05 |
| F618 | 0.3 | 0.3 | 0.3 | 0.3 | 0.3 | 0.3 | |
| Haze | 1.5 | 5.4 | 2.1 | 1.6 | 1.8 | 1.6 | 2.9 |
| Transmission | 88.6 | 87.5 | 88.4 | 88.5 | 88.0 | 88.6 | 87.6 |
| YI1925 | 3.0 | 5.1 | 3.5 | 3.2 | 3.5 | 3.5 | 8.5 |
| N. Izod | 18.3 | 14.5 | 12.8 | 12.5 | 13.4 | 2.0 | 1.2 |
| HDT 264 psi C. | 102.6 | 97.2 | — | — | — | — | 104 |
| Dynatup J | | | | | | | |
| Max Ld./Std. | 59.4/ | 54.2 | 65.9 | — | — | — | 62.2 |
| Std | 1.86 | 1.45 | 1.54 | — | — | — | 3.04 |
| Total En | 68.4 | 62.6 | 70.5 | — | — | — | 73 |
| Std | 2.87 | .02 | 1.25 | — | — | — | 1.86 |
| Tensile .2″ min | | | | | | | |
| Yield Stress | — | 7105 | — | — | — | — | — |
| Elongation Break | — | 98.9 | — | — | — | — | — |
| Mod | — | 303109 | — | — | — | — | — |
| Kayness 287.8 C. | | | | | | | |
| 100/s | 3960 | 3350 | 3001 | | | | 2961 |
| 100/s | 3960 | 3220 | 2948 | | | | 2828 |
| 1000/s | 2220 | 1390 | 1431 | | | | 1498 |
| 1000/s | 2220 | 1390 | 1425 | | | | 1534 |
| 1000/s | 2210 | 1380 | 1432 | | | | 1544 |

As shown in the examples above, the use of bulk MBS of the present invention as a dispersed phase surprisingly and unexpectedly produces compositions with high clarity, high impact strength, high HDT, and excellent flow. Applicants have also shown the use of the bulk MBS, even in small amounts, provide the desired improved properties.

1. A transparent/translucent molding composition having improved ductility, chemical resistance and melt flow properties comprising a blend of:
a) a resin blend of a polycarbonate resin and a miscible additive having a lower refractive index than the polycarbonate polymer which additive is selected from the group consisting of
(i) a cycloaliphatic polyester resin, said cycloaliphatic polyester resin comprising the reaction product of an aliphatic C₂-C₁₂ diol or chemical equivalent and a C₆-C₁₂ aliphatic diacid or chemical equivalent, said cycloaliphatic polyester resin containing at least about 80% by weight of a cycloaliphatic dicarboxylic acid, or chemical equivalent, and/or of a cycloaliphatic diol or chemical equivalent;
(ii) a resorcinol bis (diphenylphosphate);
(iii) a polycarbonate copolymer; or
(iv) mixtures thereof;
b) an dispersed phase comprising an impact modifying amorphous resin having a refractive index from about 1.46 to about 1.58 for increasing the low temperature ductility of the resin molding composition;
wherein said miscible blend of polycarbonate and miscible additive having an index of refraction which substantially matches (transparency) or almost matches (translucency) the index of refraction of said impact modifier.

2. A transparent/translucent molding composition according to claim 1 in which the cycloaliphatic polyester resin comprises the reaction product of a C₆-C₁₂ cycloaliphatic diol or chemical equivalent and a C₆-C₁₂ cycloaliphatic diacid or chemical equivalent.

3. A transparent/translucent molding composition according to claim 2 comprising: a preblend of polycarbonate resin and cycloaliphatic polyester resin wherein the ratio of polycarbonate resin to cyloaliphatic polyester resin is from 95/5 to 20/80; from 1 to 30% by weight of the impact modifying amorphous resin.

4. A transparent/translucent molding composition according to claim 1 in which the impact modifying amorphous resin is selected from the group consisting of graft or core-shell acrylic rubbers, diene rubber polymers and silicone rubber polymers.

5. A transparent/translucent molding composition according to claim 4 in which the impact modifying amorphous resin comprises a MBS core-shell polymer.

6. A transparent/translucent molding composition according to claim 5 in which the impact modifying amorphous resin comprises an ABS rubber.

7. A transparent/translucent molding composition of claim 1 where the blend has % transmittance of greater than or equal to 75%.

8. A transparent/translucent molding composition of claim 1 where the blend has a glass transition temperature of from about 60 to 150° C.

9. A transparent/translucent molding composition according to claim 1 with the addition of about 0.0001 to about 7 percent by weight of metal or mineral flakes for imparting a desired visual effect, said impact modifier enhancing the impact strength of molded composition as compared to a molding composition absent said impact modifier.

10. A transparent/translucent molding composition according to claim 9 wherein said flakes are aluminum.

11. A transparent/translucent molding composition according to claim 9 wherein the flakes comprise from about 0.05 to about 5.0 weight percent of the resin composition.

12. A transparent/translucent resin molding composition according to claim 9 wherein said flakes are metal and range in size from 17.5 microns to 650 microns.

13. A transparent/translucent resin molding composition according to claim 9 wherein the flakes are metal and are selected from the group consisting of metals of Group I-B, III-A, IV, VI-B and VIII of the periodic table and physical mixtures and alloys of these metals.

14. A transparent/translucent molding composition according to claim 9 wherein the flakes are mica.

15. A transparent/translucent molding composition according to claim 9 wherein the flakes are metal and selected from the group consisting of aluminum, bronze, brass, chromium, copper, gold, iron, molybdenum, nickel, tin, titanium and zinc, alloys of these metals and physical mixtures thereof.

16. A transparent/translucent molding composition according to claim 9 further comprising a background colorant having a different coloration than said flakes.

17. A transparent/translucent molding composition according to claim 16 wherein said colorant is selected from the group consisting of carbon black, phthalocyanine blues, phthalocyanine greens, anthraquinone dyes, scarlet 3b Lake, azo compounds, acid azo pigments, quinacridones, chromophthalocyanine pyrrols, halogenated phthalocyanines, quinolines, heterocyclic dyes, perinone dyes, anthracenedione dyes, thioxanthene dyes, parazolone dyes and polymethine pigments

18. A transparent/translucent molding composition of claim 1 where the blend further contains an effective amount of a stabilizer to prevent color formation.

19. A transparent/translucent molding composition of claim 5 or 6 where stabilizer is chosen from the group consisting of: phosphorus oxo acids, acid organo phosphates, acid organo phosphites, acid phosphate metal salts, acidic phosphite metal salts or mixture thereof giving an article with greater than or equal to about 70% transmittance.

20. A transparent/translucent molding composition of claim 1 where the cycloaliphatic polyester is comprised of cycloaliphatic diacid and cycloaliphatic diol units.

21. A transparent/translucent molding composition of claim 20 where the polyester is polycyclohexane dimethanol cyclohexane dicarboxylate (PCCD).

22. A transparent/translucent molding composition of claim 21 where the polycarbonate is BPA-PC and the cycloaliphatic polyester is PCCD.

23. A transparent/translucent molding composition of claim 22 where the ratio of cycloaliphatic polyester to polycarbonate in the blend is 5/95 to 80/20.

24. A transparent/translucent molding composition of claim 23 wherein said blend further contains an effective amount of a stabilizer to prevent color formation.

25. A transparent/translucent molding composition of claim 24 wherein said stabilizer is chosen from the group consisting of: phosphorus oxo acids, acid organo phosphates, acid organo phosphites, acid phosphate metal salts, acidic phosphite metal salts or mixture thereof for making a molded article with greater than or equal to about 75% transmittance.

26. A transparent/translucent molding composition of claim 25 wherein said cycloaliphatic polyester is comprised of cycloaliphatic diacid and cycloaliphatic diol units.

27. A process for molding articles comprising the steps of forming a resin blend of a cycloaliphatic polyester and polycarbonate, mixing said blend with an impact modifier to from another blend, and molding a transparent article from said other blend wherein said resin blend of cycloaliphatic polyester and said polycarbonate has an index of refraction substantially matching the index of refraction of said impact modifier.

28. A process for molding a transparent articles comprising the steps of selecting a transparent impact modifier having a predetermined index of refraction, forming a resin blend of a blend of cycloaliphatic polyester and polycarbonate wherein said blend is mixed in proportions for matching said predetermined index of refraction, and molding a substantially transparent article.

29. A process for molding a transparent articles of claim 28 wherein said molding is carried out above the glass transition temperature of said resin blend, said resin blend having a glass transition temperature of from about 60 to 150° C.

30. A process for molding a transparent articles of claim 29 wherein said molding is carried out by injection molding.

31. A process for forming a molding composition for preparing transparent articles comprising the steps of selecting a transparent impact modifier having a predetermined index of refraction, forming a resin blend of a blend of cycloaliphatic polyester and polycarbonate wherein said blend is mixed in proportions for matching said predetermined index of refraction, and molding a substantially transparent article.

32. A process for forming a molding composition of claim 31 wherein said molding is carried out above the glass transition temperature of said resin blend, said resin blend having a glass transition temperature of from about 60 to 150° C.

33. A process for forming a molding articles of claim 32 wherein said molding is carried out by injection molding.

34. A transparent extrusion sheet product (thickness from 10 um to 12 mm.) according claim 1 having improved ductility, chemical resistance, hinge ductility, punch ductility and showing easier processing such as vacuum forming at shorter heating times and cold forming at lower temperatures compared to polycarbonate.

35. A transparent/translucent molding composition having improved ductility, chemical resistance and melt flow properties comprising a blend of:
a) a resin blend of a polycarbonate resin and a miscible additive having a lower refractive index than the polycarbonate polymer which additive is selected from the group consisting of
(i) a cycloaliphatic polyester resin, said cycloaliphatic polyester resin comprising the reaction product of an aliphatic C₂-C₁₂ diol or chemical equivalent and a C₆-C₁₂ aliphatic diacid or chemical equivalent, said cycloaliphatic polyester resin containing at least about 80% by weight of a cycloaliphatic dicarboxylic acid, or chemical equivalent, and/or of a cycloaliphatic diol or chemical equivalent;
(ii) a resorcinol bis (diphenylphosphate);
(iii) a polycarbonate copolymer; or
(iv) mixtures thereof;
b) an dispersed phase comprising
(i) from about 25 to about 75 wt. % of styrenic monomer selected from the group consisting of styrene, p-methyl styrene, tertiary butyl styrene, dimethyl styrene, and the nuclear brominated or chlorinated derivatives thereof;
(ii) about 7 to 30 wt. % of butyl acrylate;
(iii) about 10 to 50 wt. % of methyl methacrylate; and
(iv) from about 2 to about 20 of a block copolymer selected from the group consisting of di-block and tri-block copolymers of styrene-butadiene, styrene-butadiene-styrene, styrene-isoprene, styrene-isoprene-styrene, partially hydrogenated styrene-butadiene-styrene and partially hydrogenated styrene-isoprene-styrene linear or radial block copolymers with a molecular weight of less than about 75,000.
wherein said miscible blend of polycarbonate and miscible additive having an index of refraction which substantially matches (transparency) or almost matches (translucency) the index of refraction of said impact modifier.

36. The composition of claim 35, wherein said dispersed phase is present in an amount of at least 0.1 wt. % relative to the total weight of the composition.

37. The composition of claim 36, wherein said dispersed phase is present in an amount of about 2 to 20 wt. %.

38. The composition of claim 37, wherein said dispersed phase is present in an amount of about 4 to 10 wt. %.
